(19) United States
(12) Patent Application Publication
(10) Pub. No.: US 2012/0166995 A1
(43) Pub. Date: Jun. 28, 2012

(54) SMART VIRTUAL KEYBOARD FOR TOUCHSCREEN DEVICES

(75) Inventor: David McAleer, Montreal (CA)

(73) Assignee: TELEFONAKTIEBOLAGET L M ERICSSON (PUBL), Stockholm (SE)

(21) Appl. No.: 12/978,460

(22) Filed: Dec. 24, 2010

(51) Int. Cl. G06F 3/048

(52) U.S. Cl. 715/773

(57) ABSTRACT

Presented is a system and methods for adaptively adjusting the size and position of virtual keys on a virtual keyboard based on a user signature. The user signature is generated or updated based on the user's interaction with the virtual keyboard. The user signature is persistently maintained allowing the optimization of a virtual keyboard for different users. The user signature is also transportable allowing the user to transfer device use efficiency from one device virtual keyboard to another device supporting a virtual keyboard.

### TECHNICAL FIELD

The present invention relates generally to touchscreen devices and more specifically to a virtual keyboard displayed on a touchscreen device.

### BACKGROUND

The ever increasing use of touchscreens in computing devices has exposed new efficiency problems in relation to a user interacting with a virtual keyboard displayed on a touchscreen. Historically, when a user interacted with a physical keyboard input device, a feedback connection was established between the fingers on the user's hand and the individual keys of the keyboard. As the user's fingers contacted the keyboard, either from resting between keystrokes or depressing a particular key, the user was able to determine the physical boundaries of the individual keys. The tactile boundary determination provided the user with the ability to detect and maintain a center position on the individual keys and reduced the frequency of keystroke errors. Some physical keyboards include keys with contoured shapes, e.g., a depression in the middle of the key, which tend to guide a user's finger toward the center of the key.

The growth in touchscreen devices and their associated virtual keyboards have placed the user in a position where significant amounts of time are spent correcting mistyped keys because the user no longer receives the tactile feedback from a physical keyboard with distinguishably independent keys. The user is instead required to focus his or her visual attention on the virtual keyboard to confirm that he or she are typing the correct keys instead of focusing on the displayed content, a situation unfamiliar and undesirable to most users. This problem is aggravated both as the size of touchscreens and their associated virtual keyboards approach the size of standard keyboards and users attempt to type on the virtual keyboard in the manner they would on a standard keyboard, and as the size of touchscreens get smaller with correspondingly smaller keys.

Market pressure for a solution to reduce the frequency of user errors while typing on a virtual keyboard has led to several attempts to solve the problem. For instance, a keystroke monitor can attempt to predict what the user is typing and provide the user with a list of alternatives to mistyped keys or another type of keystroke monitor can automatically correct the misspelled word based on a dictionary database. Although these methods are useful, they require a high percentage of correct keystrokes before they can successfully present useful alternatives. They do not, however, assist the user in reducing the number of mistyped keys.

Accordingly, it would be desirable to provide a solution that improves the user's efficiency in selecting the correct key from a virtual keyboard. The solution, similar to an individual user's ability to center their own fingers based on tactile feedback, should provide, among other things, an individualized ability to reduce a user's frequency of mistyping keys.

### SUMMARY

Systems and methods according to the present invention address the market needs described above by providing an adaptable virtual keyboard. A user signature is developed based on, for example, a sample of user keystrokes for individual keys. Based on an analysis of the keystroke data, individual key sensitivity areas and, possibly, individual key visible areas on the virtual keyboard are shifted in a direction dictated by the signature.

In another aspect, the individual key sensitivity area and possibly the visual area are enlarged, providing the capability for different keys to have different sizes based on a user signature. It is possible that only a subset of the total number of keys are shifted from their default positions or that different keys enclose different areas based on a particular user signature.

According to an exemplary embodiment, a user signature is developed based on a statistical analysis of the user's strike points for the individual keys of the virtual keyboard. After a statistically meaningful sample of data is collected for a virtual key, the location and size of the sensitivity area of the virtual key is adjusted if required. The virtual keys are adjusted independently because some keys can be struck more often than others and the increase in user efficiency is cumulative for each of the virtual keys.

According to another exemplary embodiment, a user signature is further developed based on user behavior. For example, the use of the backspace key or the delete key subsequent to the use of other keys can indicate a need for key adjustment of the key selected after the backspace key or delete key.

In another aspect, the adjustments to the virtual keys are based on the signature generated from the user interaction with the virtual keyboard. A different signature is generated and stored for each user allowing user personalization of the virtual keyboard. The data collection and analysis for user signature generation continues whenever the virtual keyboard is in use, providing ongoing adaptation of the virtual keyboard as the user's typing characteristics and behavior change.

According to another exemplary embodiment, a method for adjusting a virtual keyboard includes displaying a virtual keyboard having a plurality of virtual keys, obtaining data associated with a position of each of a plurality of key strikes on the virtual keyboard relative to a default position of at least one of the plurality of virtual keys which is proximate to the plurality of key strikes, and adjusting at least one of: a visual attribute of the one of the plurality of virtual keys, and a sensitivity area associated with the one of the plurality of virtual keys, based on the obtained data.

According to still another exemplary embodiment, a touchscreen device includes a touch sensitive display configured to display a virtual keyboard having a plurality of virtual keys, and a processor configured to adjust the virtual keyboard by obtaining data associated with a position of each of a plurality of key strikes on the virtual keyboard relative to a default position of at least one of the plurality of virtual keys which is proximate to the plurality of key strikes, and adjusting at least one of a visual attribute of the one of the plurality of virtual keys, and a sensitivity area associated with the one of the plurality of virtual keys, based on the obtained data.

According to yet another exemplary embodiment, a computer-storage medium encoded with a computer program for a system for adjusting a virtual keyboard includes (a) a data input component for receiving key strike data from the virtual keyboard, (b) a data collection component for organizing virtual keyboard key strike data based on a virtual key identity, (c) a data analysis component for analyzing key strike data; and (d) a data output component for sending virtual key adjustment commands to the virtual keyboard.

### BRIEF DESCRIPTION OF THE DRAWINGS

The accompanying drawings illustrate exemplary embodiments, wherein:

FIG. 1 depicts an exemplary virtual keyboard displayed on a touchscreen;

FIG. 2 depicts an exemplary virtual keyboard displayed on a touchscreen and indicating a series of user keystroke hits according to an exemplary embodiment;

FIG. 3 depicts an exemplary virtual keyboard displayed on a touchscreen after key adjustments based on a user signature according to an exemplary embodiment;

FIG. 4 shows a virtual key having a visual display area which differs from its sensitivity area according to an exemplary embodiment;

FIG. 5 depicts a system for adjusting virtual key positions and sizes on a virtual keyboard based on a user signature according to an exemplary embodiment;

FIG. 6 depicts a method of adjusting virtual key positions and sizes on a virtual keyboard based on a user signature according to an exemplary embodiment;

FIG. 7 is a flowchart depicting a method for adjusting a virtual keyboard according to an exemplary embodiment; and

FIG. 8 depicts an exemplary computing device for implementing a system for adjusting virtual key positions and sizes on a virtual keyboard based on a user signature according to an exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

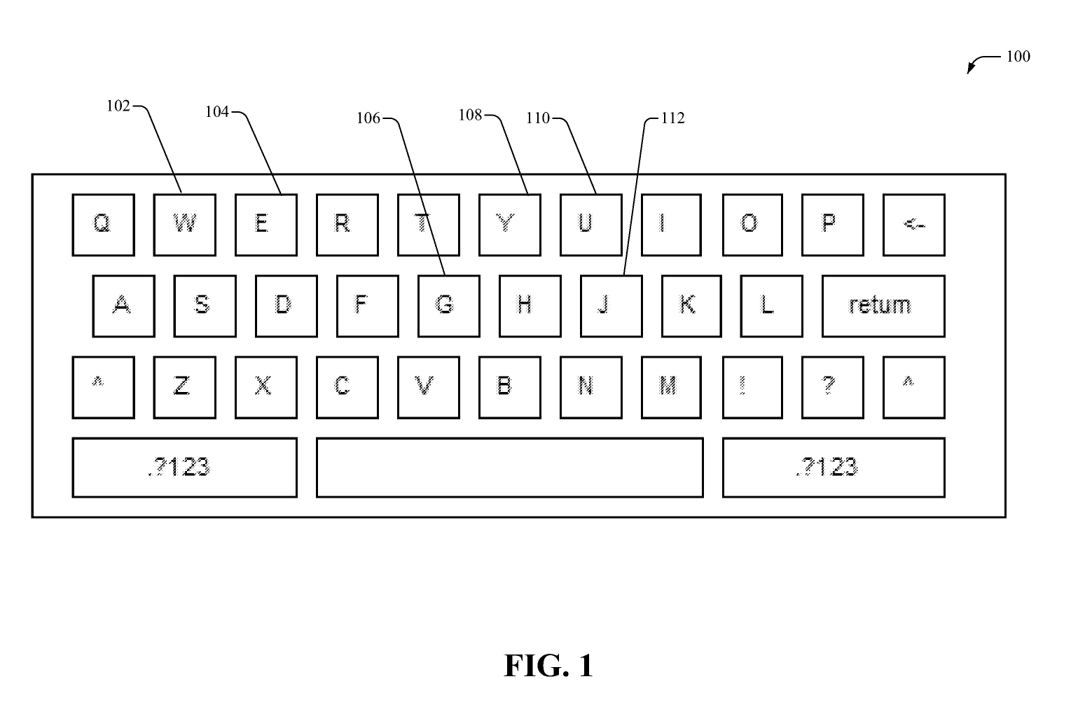

Looking first to FIG. 1, a diagram of an exemplary virtual keyboard 100 is illustrated. The exemplary virtual keyboard 100 is a “QWERTY” style keyboard of approximately the same size as a standard keyboard and is displayed on a touchscreen. It should be noted however that the present invention is applicable to virtual keyboards of layouts other than “QWERTY” style and of any size and that, therefore, the layout illustrated in FIG. 1 is purely illustrative.

A virtual keyboard according to exemplary embodiments can have a default layout, i.e., before any adjustments are made based on a user's signature as will be described below. The default layout, e.g., key alignments and spacings, of exemplary virtual keyboard 100 are typical for a standard “QWERTY” keyboard. It should be noted that all of the letter keys on the exemplary default virtual keyboard 100 are consistently sized and equally spaced from adjacent letter keys on the same row and from the row of keys above or below, if applicable. However, it should also be noted that exemplary embodiments are applicable to any default virtual keyboard regardless of key size, position or function.

For the purpose of describing exemplary embodiments, virtual keys W 102, E 104, G 106, Y 108, U 110 and J 112 are specifically referenced on default keyboard 100. It will be appreciated by those skilled in the art that the selection of these keys is arbitrary, as exemplary embodiments can operate on all keys or any subset of keys, e.g., independently and simultaneously. According to exemplary embodiments, a user signature is developed for each individual user that interacts with default virtual keyboard 100 by acquiring keystroke data from a user for one or more (or all) of the keys.

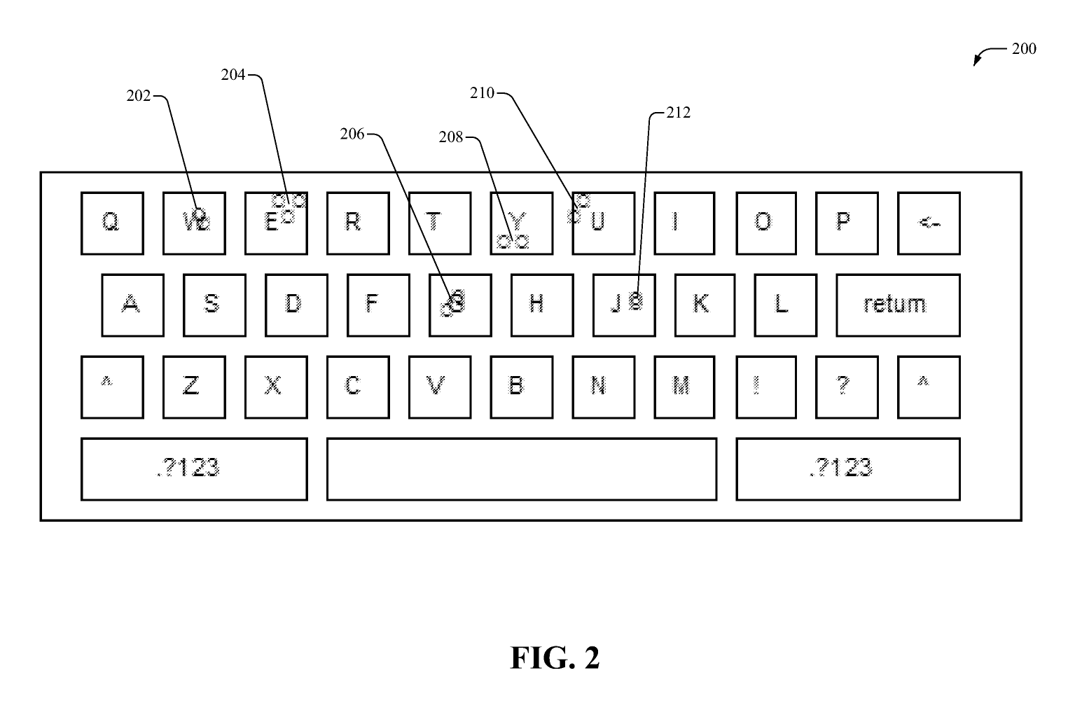

For example, looking now to FIG. 2, the keyboard of FIG. 1 is shown overlaid with key strike positions as the user interacts with the virtual keyboard 200. The illustration shows a snapshot of an exemplary embodiment for developing a user signature by collecting key strike data for analysis. In FIG. 2, key strikes from a user are illustrated as small circles overlaid on the virtual keys. However, it will be appreciated that these circles are illustrated to convey the key strike data collection process and need not actually be displayed on a virtual keyboard 200 implemented in accordance with these exemplary embodiments. Starting at 202, it can be seen that the user has struck the W 102 key twice. The key strikes are slightly to the right and above the center of the W 102 key. The key strike positions are detected and recorded by the virtual keyboard 200 for analysis and use in generating the W 102 key portion of the user signature. Next, at 204, the user has struck the E 104 key three times. The three key strikes are all in the upper right quadrant of the E 104 key. The key strike positions are also detected and recorded by the virtual keyboard 200 for analysis and use in generating the E 104 key portion of the user signature.

Continuing at 206, the user has struck the G 106 key two times. The two key strikes are relatively symmetrically offset from each other in relation to the center position of the G 106 key. The key strike positions are detected and recorded by the virtual keyboard 100 for analysis and use in generating the G 106 key portion of the user signature. Next, at 208, the user has struck the Y 108 key two times. The two key strikes are both below the center of the Y 108 key with one strike directly below the center of key Y 108 and the other strike in the lower left quadrant of key Y 108. The key strike positions are also detected and recorded by the virtual keyboard 200 for analysis and use in generating the Y 108 key portion of the user signature.

Next, at 210, the user has struck the U 110 key two times. The two key strikes are both above the center of the U 110 key with both strikes in the corner of the upper left quadrant of key U 110. The key strike positions are detected and recorded by the virtual keyboard 100 for analysis and use in generating the U 110 key portion of the user signature. Continuing at 212, the user has struck the J 112 key two times. The two key strikes are overlapping each other and to the right of the center of the J 112 key about halfway to the edge of the key. The key strike positions are also detected and recorded by the virtual keyboard 200 for analysis and use in generating the J 112 key portion of the user signature. Of course it will be appreciated by those skilled in the art that the number of key strikes which may be used to generate a per-key user signature can vary from implementation to implementation and may be fixed or variable.

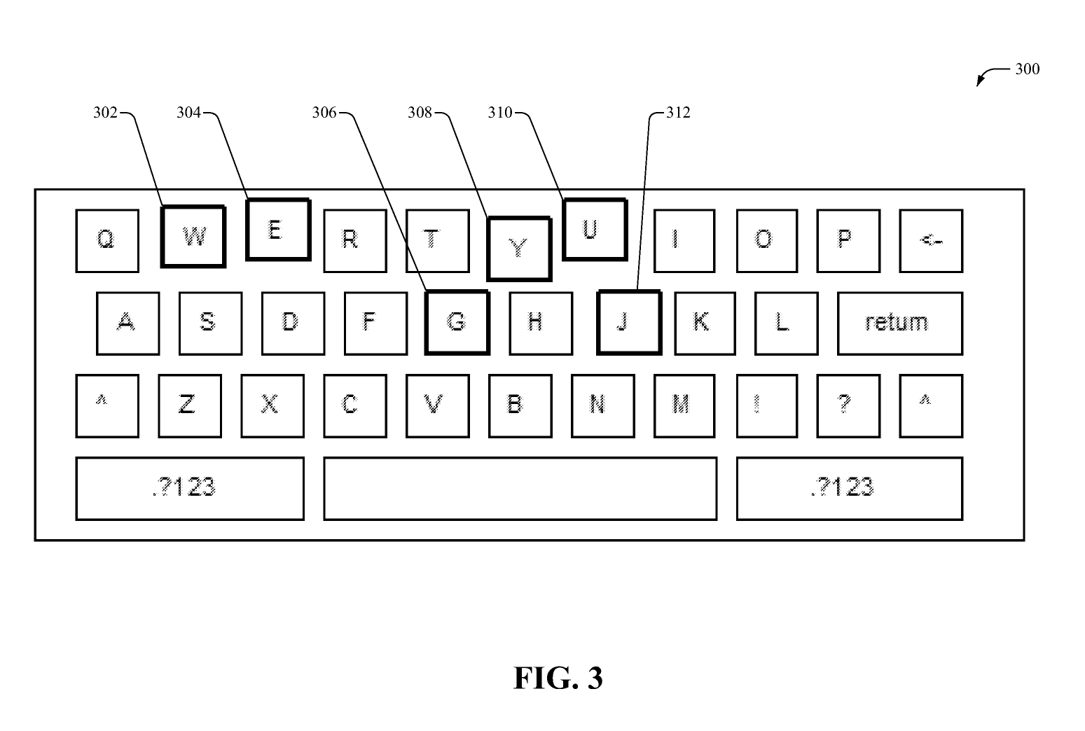

Turning now to FIG. 3, illustrated is another exemplary virtual keyboard 300, similar to the virtual keyboard 100 described in FIG. 1 and FIG. 2 but showing adjusted key positions based on the user signature that was acquired as discussed above with respect to FIG. 2. The user signature was generated by analyzing user key strike locations and behavior as previously described for FIG. 2. As indicated, a user signature can prescribe a change in virtual key position, boundaries and/or key size.

For example, starting at key W 302, the position of the W 302 is moved slightly up and to the right with respect to its original position on the virtual keyboard 100 based on the key strike data acquired for key W 302. Next at key E 304, the position of the E 304 is also moved up and to the right with respect to the original E 304 key position on the virtual keyboard 100, 200. It should be noted that although both the W 302 key and the E 304 key were moved up and to the right with respect to their original positions on the virtual keyboard 100, 200 the magnitude of the movement for the E 304 key is greater than that of the W 302 key because the user key strikes on the E 304 key were at a greater distance from the center of the E 304 key than the user key strikes on the W 302 key were from the center of the W 302 key.

Looking now to the G 306 key, the position of the G 306 key has remained effectively in its default location. The user key strike data for the G 306 key has indicated that no key relocation is necessary because the user's key strikes are symmetrically distributed around the center of the default G 306 key location. It should be noted that although an analysis is performed for every key, a key's size and/or location can remain the same as the default location for reasons such as, but not limited to, the net result of the key strike data analysis is that no movement is required or there is insufficient data to calculate a new position for a virtual key.

Continuing now to key Y 308, the position of the Y 308 key is moved down and to the left with respect to the original Y 308 key position on the virtual keyboard 100. It should be noted that as a key is relocated closer to another key, such as the Y 308 key approaching the G 306 key, it is possible for the sensitivity area and visible area of one virtual key to overlap the sensitivity area and visible area of another virtual key. Under these conditions when a user contacts the virtual keyboard 100 in an overlapped region, a determination is made concerning which key, if any, to input. In one exemplary embodiment, for this indeterminate case, the user signature determines the appropriate key to input based on which key has received the most strikes. In another exemplary embodiment, the user signature can dictate that no input is recorded for key strikes that fall in the relative center of an overlapped virtual key area.

Continuing at key U 310, the position of the U 310 key is moved up and to the left with respect to the original U 310 key position on the virtual keyboard 100. It should be readily apparent that according to at least some exemplary embodiments, virtual key relocations cannot extend beyond the limits of the virtual keyboard 100. For example, according to this exemplary embodiment, the U 310 key cannot be relocated beyond the boundary of virtual keyboard 300 located above the U 310 key. Looking now to key J 312, the position of the J 312 key is moved laterally to the right with respect to the original J 312 key position on the virtual keyboard 100. It should be noted that a statistically reliable number of key strikes are desired to determine the position to relocate a given virtual key but an estimate can be determined with as few as one or two key strikes.

In another exemplary embodiment, a purely illustrative, exemplary algorithm for determining the relocated position portion of a user signature for a virtual key includes the following calculations based on recorded key strike data. First, overlay the current virtual key location with a Cartesian coordinate system, placing the origin of the Cartesian coordinate system on the center of the virtual key. For example, the E 204 key on virtual keyboard 200 showing the key strike data can be overlaid with such a coordinate system. Second, determine the abscissa and ordinate pairs for each key strike included in the key strike data set. Continuing with the E 204 key example, the three key strike locations in the upper right quadrant are reduced to abscissa and ordinate pairs. Third, calculate the numerical average of the abscissas and the numerical average of the ordinates to create a new virtual key center point location. It should be noted that some abscissa and ordinate values can be negative numbers based on the quadrant location of the key strike. Finally, relocate the center of the virtual key to the new location described by plotting the average abscissa and average ordinate pair as indicated by the new location of the E 304 key in virtual keyboard 300.

It should be noted that the relocation of any given virtual key can be limited by the boundaries of the virtual keyboard and/or by the location of other virtual keys. This exemplary algorithm can be repeated for each virtual key or different algorithms can be applied to different virtual keys.

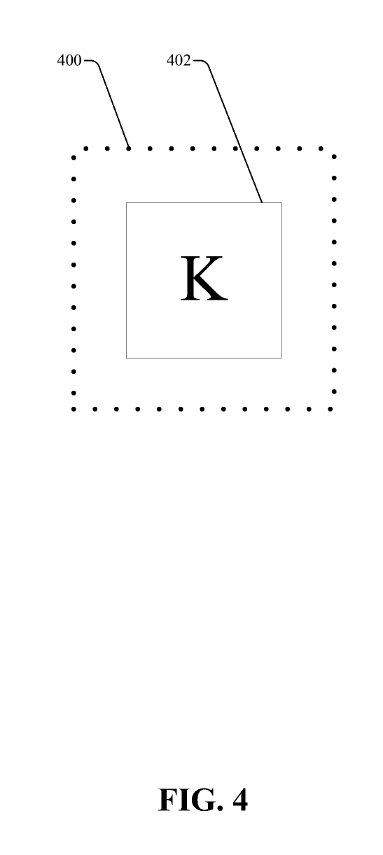

According to some exemplary embodiments, a user's signature can be used to change visible attributes of one or more keys on a virtual keyboard, e.g., a key's displayed location, displayed size and/or displayed boundaries. According to other exemplary embodiments, the visible attributes of a key on a virtual keyboard may remain unchanged, but the sensitivity area associated with that key may instead be changed based upon the user's signature. The sensitivity area in this context is the surface area on the virtual keyboard within which a key strike input will be recognized as corresponding to the associated key value. For example, as shown in FIG. 4, a user's signature could indicate that an expanded sensitivity area 400 will result in fewer mistypings of the letter ‘K’, but the visible attributes, e.g., displayed border 402 can be left in the default position on the virtual keyboard. Thus, FIG. 3 can represent a change in both the visual attributes of the virtual keys associated with the user's signature and their sensitivity areas or may, alternatively, represent a change in only the sensitivity areas of those keys which have moved relative to their default positions in FIG. 1. It should be noted that according to exemplary embodiments, therefore, the shape of the sensitivity area and the shape of the visual area, for a given virtual key, can differ. For a non-limiting example, the shape of the visual area can be a square while the shape of the sensitivity area can be a rectangle or an oval, depending on the analysis of the key strike data. It should also be noted that a visible area or a sensitivity area can take on any shape with the shape of the visible area unrelated to the shape of the sensitivity area.

Additionally, it should be noted that as used in this application, terms such as “component,” “display,” “interface,” and other similar terms are intended to refer to a computing device, either hardware, a combination of hardware and software, software, or software in execution as applied to a computing device implementing a virtual keyboard. For example, a component may be, but is not limited to being, a process running on a processor, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

Further, the term to “infer” or “inference” refer generally to the process of reasoning about or inferring states of the system, environment, user, and/or intent from a set of observations as captured via events and/or data. Captured data and events can include user data, device data, environment data, behavior data, application data, implicit and explicit data, etc. Inference can be employed to identify a specific context or action, or can generate a probability distribution over states, for example. The inference can be probabilistic in that the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

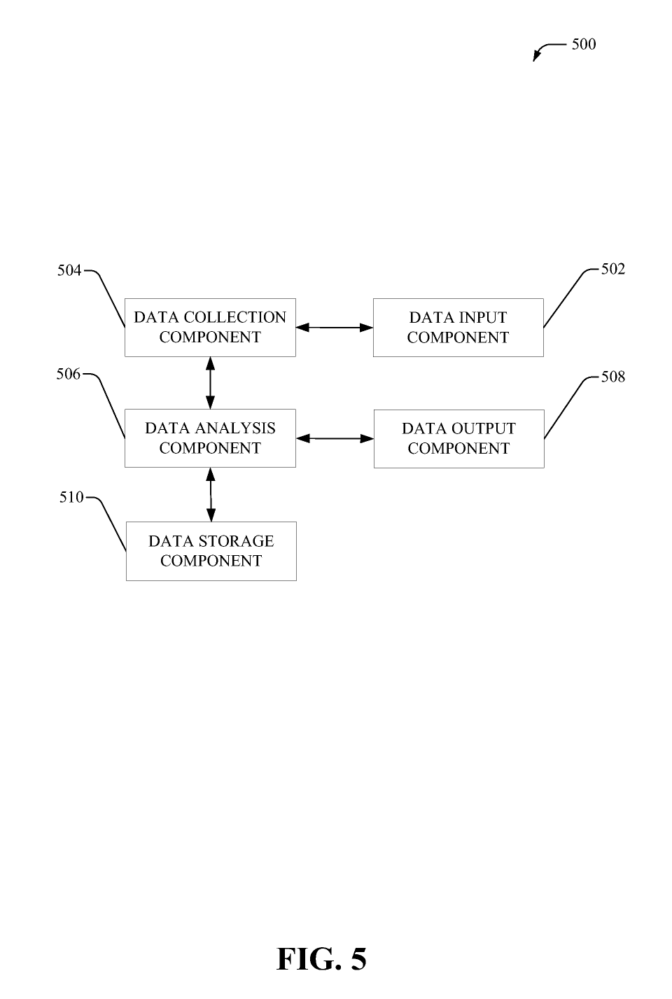

Looking now to FIG. 5, an exemplary virtual key adjustment system 500 for adjusting virtual keys on a virtual keyboard 100 based on a generated user signature is illustrated. The data input component 502 is communicatively connected to the virtual keyboard 100 and provides the ability for the virtual key adjustment system 500 to receive key strike data from the virtual keyboard 100. The key strike data includes, but is not limited to, the location on the virtual key where the user made contact with the virtual key. This location can, for example, be defined as a point or set of points. In another aspect, the data input component 502 provides information regarding user behavior such as use of the backspace and the delete keys. For example, the data input component 502 can provide information about the keys struck before and after the backspace key allowing inference of what key was mistyped and what key was desired.

The data collection component 504 provides the ability to organize the data provided by the data input component 502 based on differing criteria required by the virtual key adjustment system 500. For example the key strike data provided by the data input component 502 is organized such that all the key strikes associated with a particular virtual key are available as a group. In another example, key strike data reflecting strikes outside of the sensitivity area of all keys are organized based on their proximity to adjacent virtual keys and identity of the next valid virtual key strike. From this association, inferences of intended key strikes can be determined.

In another aspect, the data collection component 504 can keep a count of the number of key strikes on a per key basis providing for notification when a statistically significant number of key strikes have occurred for a given virtual key. The threshold number of key strikes is a configurable value based on the algorithm assigned to the key. Further, providing notification can also allow triggering of an update of the user signature.

The data analysis component 506 provides the capability to apply algorithms to the data organized and provided by the data collection component 504. As previously illustrated with an exemplary algorithm, the key strike data can be used to generate a portion of the user signature allowing determination of a new center point for a virtual key. The algorithm applied to calculate a new virtual key position can change over time based on key strike patterns and can vary from one virtual key to the next.

The data output component 508 is communicatively connected to the virtual keyboard 100 and provides the capability for the virtual key adjustment system 500 to send virtual key location and size information to the virtual keyboard 100. On a frequency specified and configurable by the virtual key adjustment system 500, the data output component 508 is provided virtual key location and size information from the data analysis component 506 and the data output component 508 instructs the virtual keyboard 100 to update the virtual key sensitivity area and, if desired, the virtual key visible area for each included virtual key. It should be noted that it is not necessary to update all of the virtual keys on a virtual keyboard 100 at one time and any subset of virtual keys can be updated based on data provided by the data input component 502. In another aspect, it is not required to update both the sensitivity area and the visible area at the same time or at all. The virtual key adjustment system 500 can update the sensitivity area and the visible area independently based on criteria specified in the user signature. That is, the visible depiction of the keys on the virtual keyboard may remain the same even after a user's signature is applied to change the sensitivity area associated with one or more of the virtual keys, as mentioned above.

The data storage component 510 provides the capability to accumulate and persistently archive input data provided by the data input component 502 along with analysis information and user signatures generated by the data analysis component 506. The user signatures can be retrieved from the data storage component 510 and provided to the data output component 508 to configure the virtual keyboard 100 for a different user. In another aspect, a currently loaded user signature can be updated by the data analysis component 506 based on new data provided by the data input component 502 and then returned to the data storage component 510 for future retrieval.

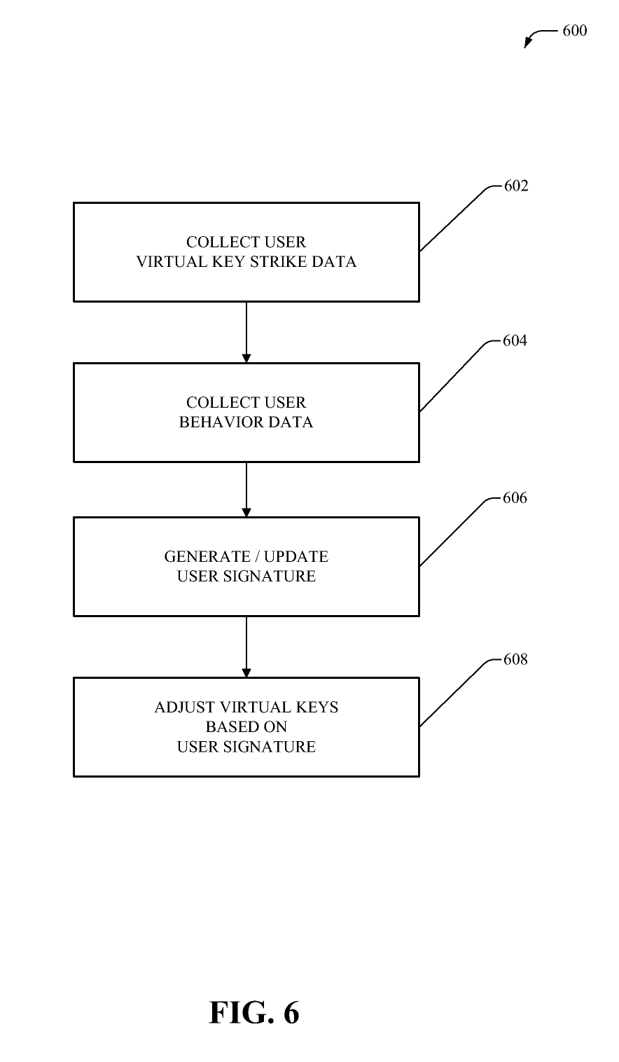

Looking now to FIG. 6, a method 600 based on a user signature for adjusting the virtual keys of a virtual keyboard 100 is depicted. Starting at step 602, user virtual key strike data is collected as the user interacts with the virtual keyboard 100. Virtual key strike data is collected on an individual virtual key basis allowing an analysis for each virtual key. In one aspect, each virtual key strike that falls within the sensitivity area of a given virtual key is reported for the struck virtual key. In another aspect, virtual key strikes that fall outside the boundary of any virtual key can be reported for one or more virtual keys depending on the location of the virtual key strike and its proximity to surrounding virtual keys.

Continuing to step 604, user virtual key behavior data is collected to merge with the user virtual key strike data. User virtual key behavior data relates to the use of correction keys or keys intended to activate a secondary function of a virtual key. For example, control virtual keys such as a backspace virtual key, a shift virtual key or an enter virtual key can be reported for virtual keys struck preceding and/or following the struck control virtual key. In one aspect, the information provided by the user virtual key behavior data of the backspace key allows for the elimination of a user virtual key strike data point on one virtual key and the addition of an undetected user virtual key strike data point for a different virtual key.

At step 606, the user signature is generated or updated based on an analysis of the user virtual key strike data and the user behavior data. The user signature maintains individual analysis for each virtual key allowing the adjustment of individual keys as sufficient virtual key strike data becomes available. Algorithms such as the exemplary algorithm described previously are applied to the virtual key strike data and the virtual key behavior data to produce a relocation position for each virtual key. The algorithm applied to one virtual key in a user signature can be different than the algorithm applied to a different virtual key in said user signature. The generated user signature is archived for reuse as the device user changes or the user signature can be transferred to another device for the user's convenience and secondary device use optimization.

Finally, at step 608, the virtual keys are adjusted based on the user signature. Each virtual key is adjusted independently based on data and an algorithm selected for that virtual key. One to all of the virtual keys can be adjusted based on the results of the analysis. An adjustment of a virtual key can consist in part in a movement of the virtual key in any direction in relation to the current position of said virtual key.

In another aspect, the size of any number of virtual keys can be increased or decreased in any combination based on the analysis results specified in the user signature. For example, the sensitivity size of the W 102 key can be made larger and the E 104 key can be made smaller as a result of the adjustments specified by the user signature. In this example, the user strikes around but outside the sensitivity area of the W 102 virtual key in areas not enclosed by any virtual key sensitivity area. Following each of these errant strikes the user strikes near the center of the W 102 virtual key. The described behavior is analyzed and a determination is made and recorded as part of the user signature. In this example, the user signature dictates that the sensitivity area size of the W 102 virtual key is expanded to provide a greater probability that the user strikes within the sensitivity area boundary of the W 102 virtual key.

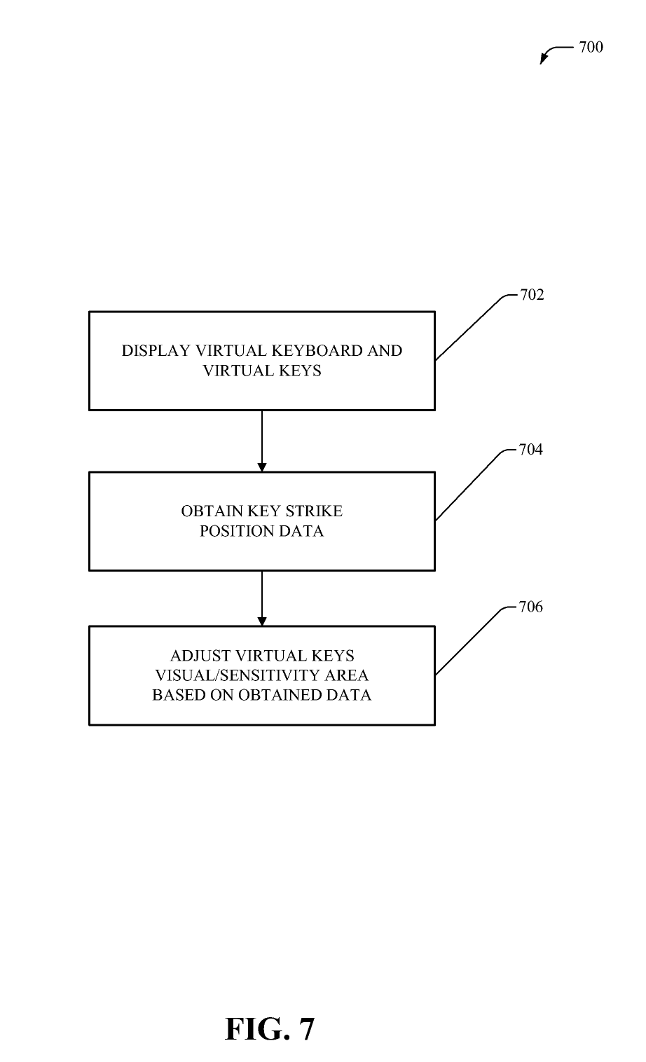

Looking now to FIG. 7, a method 700 for adjusting a virtual keyboard is depicted. Beginning with step 702, the method displays a virtual keyboard and the associated virtual keys. Each virtual key has a default location and the virtual keyboard is configured with each virtual key in the default location. In one exemplary embodiment, an exemplary default virtual key configuration can be a QWERTY style keyboard arrangement.

Continuing to step 704, the method obtains data from the virtual keyboard. The data is associated with the position of user key strikes for the virtual keys in relation to the default position of the virtual keys. In one exemplary embodiment, a user strikes the “G” key three times and the method obtains the location of the three key strikes in relation to a reference point on the “G” key.

Next, at step 706, the method adjusts the position of the virtual keys based on the obtained data. In one exemplary embodiment the method can adjust the position of the sensitivity area of a virtual key without adjusting the visible area of the virtual key displayed on the virtual keyboard. In another exemplary embodiment, the method can adjust both the sensitivity area and the visual area of a virtual key.

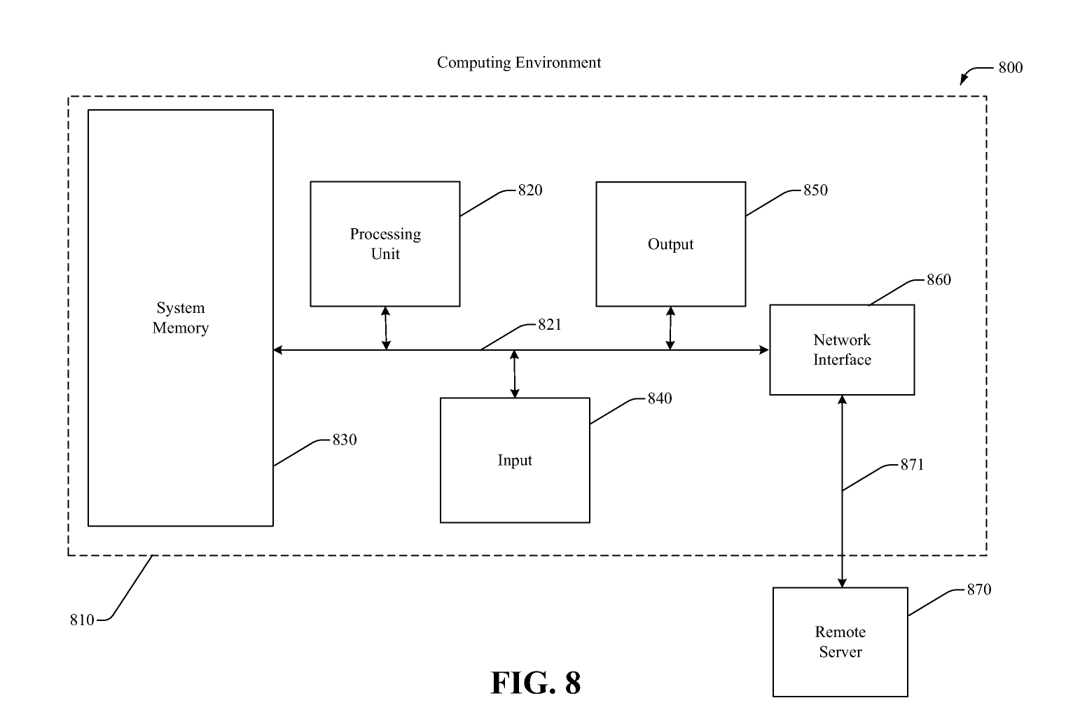

FIG. 8 illustrates an example of a suitable computing system environment 800 in which the claimed subject matter can be implemented, although as made clear above, the computing system environment 800 is only one example of a suitable computing environment for a mobile device and is not intended to suggest any limitation as to the scope of use or functionality of the claimed subject matter. Further, the computing environment 800 is not intended to suggest any dependency or requirement relating to the claimed subject matter and any one or combination of components illustrated in the example operating environment 800.

Looking now to FIG. 8, an example of a device for implementing the previously described innovation includes a general purpose computing device in the form of a computer 810. Components of computer 810 can include, but are not limited to, a processing unit 820, a system memory 830, and a system bus 821 that couples various system components including the system memory to the processing unit 820. The system bus 821 can be any of several types of bus structures including a memory bus or memory controller, a peripheral bus, and a local bus using any of a variety of bus architectures.

Computer 810 can include a variety of computer readable media. Computer readable media can be any available media that can be accessed by computer 810. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media can embody computer readable instructions, data structures, program modules or other data in a modulated data signal such as a carrier wave or other transport mechanism and can include any suitable information delivery media.

The system memory 830 can include computer storage media in the form of volatile and/or nonvolatile memory such as read only memory (ROM) and/or random access memory (RAM). A basic input/output system (BIOS), containing the basic routines that help to transfer information between elements within computer 810, such as during start-up, can be stored in memory 830. Memory 830 can also contain data and/or program modules that are immediately accessible to and/or presently being operated on by processing unit 820. By way of non-limiting example, memory 830 can also include an operating system, application programs, other program modules, and program data.

The computer 810 can also include other removable/non-removable and volatile/nonvolatile computer storage media. For example, computer 810 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 821 through a non-removable memory interface such as an interface, and a magnetic disk drive or optical disk drive can be connected to the system bus 821 by a removable memory interface, such as an interface.

A user can enter commands and information into the computer 810 through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processing unit 820 through user input 840 and associated interface(s) that are coupled to the system bus 821, but can be connected by other interface and bus structures, such as a parallel port, game port or a universal serial bus (USB).

A graphics subsystem can also be connected to the system bus 821. In addition, a monitor or other type of display device can be connected to the system bus 821 through an interface, such as output interface 850, which can in turn communicate with video memory. In addition to a monitor, computers can also include other peripheral output devices, such as speakers and/or printing devices, which can also be connected through output interface 850.

The computer 810 can operate in a networked or distributed environment using logical connections to one or more other remote computers, such as remote server 870, which can in turn have media capabilities different from device 810. The remote server 870 can be a personal computer, a server, a router, a network PC, a peer device or other common network node, and/or any other remote media consumption or transmission device, and can include any or all of the elements described above relative to the computer 810. The logical connections depicted in FIG. 8 include a network 871, such as a local area network (LAN) or a wide area network (WAN), but can also include other networks/buses.

When used in a LAN networking environment, the computer 810 is connected to the LAN 871 through a network interface or adapter. When used in a WAN networking environment, the computer 810 can include a communications component, such as a modem, or other means for establishing communications over a WAN, such as the Internet. A communications component, such as a modem, which can be internal or external, can be connected to the system bus 821 through the user input interface at input 840 and/or other appropriate mechanism.

In a networked environment, program modules depicted relative to the computer 710, or portions thereof, can be stored in a remote memory storage device. It should be noted that the network connections shown and described are exemplary and other means of establishing a communications link between the computers can be used.

The above-described exemplary embodiments are intended to be illustrative in all respects, rather than restrictive, of the present innovation. Thus the present innovation is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for adjusting a virtual keyboard comprising:
displaying a virtual keyboard having a plurality of virtual keys;
obtaining data associated with a position of each of a plurality of key strikes on said virtual keyboard relative to a default position of at least one of said plurality of virtual keys which is proximate to said plurality of key strikes; and
adjusting at least one of:
a visual attribute of said one of said plurality of virtual keys; and
a sensitivity area associated with said one of said plurality of virtual keys, based on said obtained data.

2. The method of claim 1, further comprising obtaining data associated with a user's behavior while said user interacts with said virtual keyboard.

3. The method of claim 2 wherein said data associated with said user's behavior is combined with said data associated with said position of each of a plurality of key strikes for adjusting said at least one of said visual attribute and said sensitivity area.

4. The method of claim 1 wherein adjusting a visual attribute of said one of said plurality of virtual keys further comprises:
adjusting a virtual key center position;
adjusting a virtual key size; and
adjusting a virtual key boundary location.

5. The method of claim 1, further comprising obtaining data for a plurality of virtual keys for a specific user to generate a user's signature.

6. The method of claim 1, further comprising adjusting only the sensitivity area.

7. A touchscreen device comprising:
a touch sensitive display configured to display a virtual keyboard having a plurality of virtual keys; and
a processor configured to adjust said virtual keyboard by obtaining data associated with a position of each of a plurality of key strikes on said virtual keyboard relative to a default position of at least one of said plurality of virtual keys which is proximate to said plurality of key strikes; and adjusting at least one of:
a visual attribute of said one of said plurality of virtual keys; and
a sensitivity area associated with said one of said plurality of virtual keys, based on said obtained data.

8. The device of claim 7, wherein said processor obtains data associated with a user's behavior while interacting with said virtual keyboard.

9. The device of claim 8, wherein said processor combines said user behavior data with said data associated with said position of each of a plurality of key strikes for adjusting said at least one of said visual attribute and said sensitivity area.

10. The device of claim 7 wherein said processor adjusts said visual attribute of said one of said plurality of virtual keys further by adjusting at least one of: (a) adjusting a virtual key center position; (b) adjusting a virtual key size; and (c) adjusting a virtual key boundary location.

11. The device of claim 7, wherein said processor obtains data for a plurality of virtual keys for a specific user to generate a user's signature.

12. The device of claim 7, wherein said processor adjusts only the sensitivity area.

13. A computer-storage medium encoded with a computer program for a system for adjusting a virtual keyboard comprising:
(a) a data input component for receiving key strike data from the virtual keyboard;
(b) a data collection component for organizing virtual keyboard key strike data based on a virtual key identity;
(c) a data analysis component for analyzing key strike data; and
(d) a data output component for sending virtual key adjustment commands to the virtual keyboard.

14. The computer-storage medium of claim 13 wherein said data input component further comprises receiving user behavior data from the virtual keyboard.

15. The computer-storage medium of claim 14 wherein said data collection component further comprises organizing said user behavior data.

16. The computer-storage medium of claim 15 wherein said data analysis component further comprises analyzing said user behavior data.

17. The computer-storage medium of claim 16, further comprising a data storage component for archiving data from said data analysis component.

18. The computer-storage medium of claim 13 wherein said data analysis component further comprises generating a user signature based on said data analysis.

19. The computer-storage medium of claim 18 wherein said data analysis component further comprises applying an algorithm to said key strike data for generating said user signature.

20. The computer-storage medium of claim 19 wherein said data analysis component further comprises applying a plurality of algorithms to said key strike data based on individual virtual keys.
